(19) United States
(12) Patent Application Publication
(10) Pub. No.: US 2004/0255414 A1
(43) Pub. Date: Dec. 23, 2004

(54) Double-ended driver with inner and outer pipe-cleaning attachments

(76) Inventor: Charles A. Tulipana, Kansas City, MO (US)

Correspondence Address: HOVEY WILLIAMS LLP, Suite 400, 2405 Grand, Kansas City, MO, 64108, US

(21) Appl. No.: 10/600,320

(22) Filed: Jun. 20, 2003

(51) Int. Cl. B08B 9/02; B08B 9/023; A46B 13/02

(52) U.S. Cl. 15/104.04; 15/104.095

(57) ABSTRACT

A tool (10) configured for cleaning the inside and outside circumferential surfaces of the ends of a pipe (P₁) is disclosed. The tool (10) broadly includes a driver (12), an inner pipe-cleaning bit (14) removably coupled to the driver (12), and an outer pipe-cleaning bit (16) removably coupled to the driver (12). The driver (12) includes first and second sockets (20, 22) and a power source (24) in power communication with the first and second sockets (20, 22) for selectively rotating the sockets (20, 22). The sockets (20, 22) are configured to removably receive the bits (14, 16). The inner pipe-cleaning bit (14) includes a brush (40) having a plurality of bristles (48) for insertion into the end of the pipe (P₁) for effectively cleaning and deburring the inner circumferential surface of the end of the pipe (P₁) when the bit (14) is rotated. The outer pipe-cleaning bit (16) includes a cylinder (52) and a plurality of bristles (54) fixed relative to the cylinder (52) for receiving the end of a pipe (P₂) for effectively cleaning and deburring the outer circumferential surface of the pipe (P₂) received therein when the bit (16) is rotated.

### BACKGROUND OF THE INVENTION

1. Field of the Invention

The present invention relates generally to tools for installing and repairing plumbing systems. More specifically, the present invention concerns a powered rotary tool including dual rotary drives that rotatably drive inner and outer pipe-cleaning attachments.

2. Description of the Prior Art

Household and industrial plumbing systems typically include a plurality of fixtures joined to a source (e.g., water, gas, etc.) by interconnecting pipes. The interconnected pipes commonly include metal or plastic tubes (e.g., copper, PVC, etc.) that are soldered or adhesively joined at their ends to metal or plastic fittings. It is desirable to clean and debur the inner and outer circumferential surfaces of the ends of the pipes and the fittings prior to applying the solder or adhesive.

Scarifying tools for cleaning and deburring the inner and outer circumferential surfaces of the ends of plumbing pipes and fittings are known in the art. However, these prior art scarifying tools are problematic and have several limitations. For example, prior art scarifying tools are all manually rotated to clean and debur the end of the pipe or fitting. Manual rotation is undesirable because it can result in worker fatigue and/or injury, particularly when installing a plumbing system. Plumbing system installation can involve hundreds of interconnected pipes and fittings that must be joined together in a relatively short amount of time (e.g., one or two days). Furthermore, prior art scarifying tools typically have either an inside or an outside pipe cleaning member, or both, integrally formed with a handle member. This integral configuration is undesirable because it requires the entire tool, handle and all, to be discarded when the pipe cleaning member wears out. Plumbing system installations may require several pipe cleaning members to complete the installation.

### SUMMARY OF THE INVENTION

The present invention provides and improved scarifying tool that does not suffer from the problems and limitations of the prior art scarifying tools as set forth above. The inventive tool provides a powered rotary driver for rotating detachable inner and outer pipe-cleaning attachments.

A first aspect of the present invention concerns a pipe-cleaning bit for cleaning the inner circumferential surface of the end of a pipe when used in a power driver including at least one rotatable socket. The pipe-cleaning bit broadly includes a shaft operable to removably couple with the socket and a brush fixed relative to the shaft for cleaning the inner circumferential surface of the end of the pipe when the shaft is rotated. The shaft presents a rotational axis. The brush includes a plurality of bristles, at least some of which extend radially outward from the rotational axis.

A second aspect of the present invention concerns a pipe-cleaning bit for cleaning the outside circumferential surface of the end of a pipe when used in a power driver including at least one rotatable socket. The pipe-cleaning bit broadly includes a shaft operable to removably couple with the socket, a cylinder fixed relative to the shaft, and a plurality of bristles fixed relative to the cylinder for cleaning the outside circumferential surface of the end of the pipe when the shaft is rotated. At least some of the bristles extend radially inward relative to the cylinder.

A third aspect of the present invention concerns a double-ended driver for selectively rotating at least a first and a second bit. The driver broadly includes a housing, a first socket rotatably supported on the housing, a second socket rotatably supported on the housing, and a motorized power source in power communication with the first and second sockets for selectively rotating the sockets. The first socket is operable to removably receive the first bit. The second socket is spaced from the first socket and is operable to removably receive the second bit. The power source is at least partially contained within the housing.

A fourth aspect of the present invention concerns a pipe-cleaning bit in a power driver. The pipe-cleaning bit broadly includes a shaft rotatable about a rotational axis and a plurality of bristles fixed relative to the shaft and operable to clean the end of the pipe when the shaft is rotated.

A fifth aspect of the present invention concerns a tool for cleaning the inside and outside circumferential surfaces of the end of a pipe. The tool broadly includes a driver, an inner pipe-cleaning bit, and an outer pipe-cleaning bit. The driver includes a first socket, a second socket spaced from the first socket, and a motorized power source in power communication with the first and second sockets for selectively rotating the sockets. The inner pipe-cleaning bit is removably coupled to the first socket and is operable to clean the inside circumferential surface of the end of the pipe when the first socket is rotated. The outer pipe-cleaning bit is removably coupled to the second socket and is operable to clean the outside circumferential surface of the end of the pipe when the second socket is rotated.

A sixth aspect of the present invention concerns a method for cleaning the inside and outside circumferential surfaces of the end of a pipe. The method broadly includes the steps of coupling a wire brush to a power driver, inserting the wire brush into the inside of the end of the pipe, and rotating the wire brush inside the pipe without rotating the hands of the user.

Other aspects and advantages will be apparent from the following detailed description of the preferred embodiments and the accompanying drawing figures.

### BRIEF DESCRIPTION OF THE DRAWING FIGURES

Preferred embodiments of the present invention is described in detail below with reference to the attached drawing figures, wherein:

FIG. 1 is a perspective view of a double-ended driver with inner and outer pipe-cleaning attachments constructed in accordance with a preferred embodiment of the present invention and shown in a user's hand with the inner pipe-cleaning attachment being inserted into the end of a pipe;

FIG. 2 is a perspective view of the driver illustrated in FIG. 1 with the inner pipe-cleaning attachment removed and shown with the end of a pipe inserted into the outer pipe-cleaning attachment;

FIG. 3 is a perspective assembly view of the driver with the inner and outer pipe-cleaning attachments;

FIG. 4 is a side elevational view of the driver with the inner and outer pipe-cleaning attachments with the internal components of the driver shown in phantom;

FIG. 5 is a sectional view of the outer pipe-cleaning attachment taken substantially along line 5-5 of FIG. 4 and shown with the end of a pipe (illustrated in phantom) inserted therein; and

FIG. 6 is a sectional view of the outer pipe-cleaning attachment taken substantially along line 6-6 of FIG. 5 and shown with the end of a pipe (in phantom) inserted therein.

### DETAILED DESCRIPTION OF THE PREFERRED EMBODIMENTS

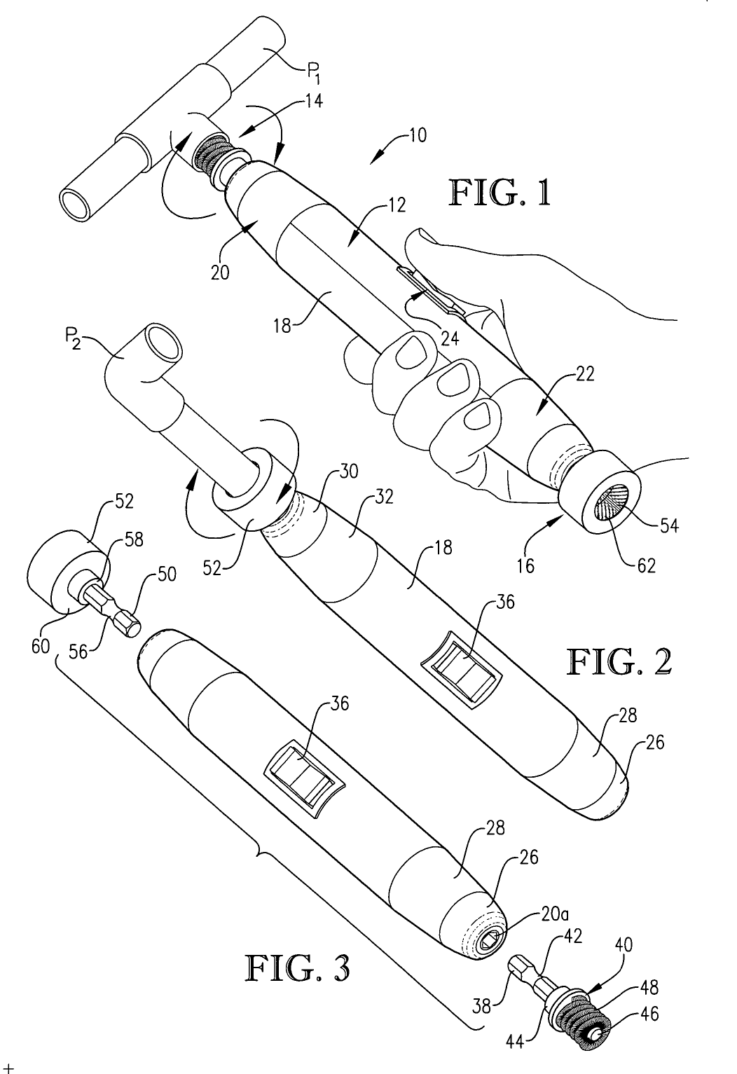

FIG. 1 illustrates a tool 10 constructed in accordance with a preferred embodiment of the present invention and configured for cleaning the inside and outside circumferential surfaces of the ends of pipe P₁. The illustrated pipe P₁ is a copper plumbing pipe including two pipe sections joined by a copper T-type fitting. The principles of the present invention are particularly well-suited for tools for cleaning and deburring copper plumbing piping and fittings, however, these principles are equally applicable to tools for cleaning and deburring virtually any type of piping that is joined by fittings (e.g., plastic piping that is joined adhesively, metal piping formed from materials other than copper that is joined by soldering, welding, etc.). FIG. 1 illustrates the tool 10 inserted into the inside of the fitting of the pipe P₁ for cleaning the interior circumferential surface thereof, however, it will be appreciated that the tool 10 is equally well-suited for cleaning both the inside and outside circumferential surfaces of both fittings as well as the pipe sections. For example, FIG. 2 illustrates the tool 10 with the end of a pipe P₂ inserted into the tool 10 for cleaning the outside circumferential surface of the pipe section of the pipe P₂. The tool 10 broadly includes a driver 12, an inner pipe-cleaning bit 14 removably coupled to the driver 12, and an outer pipe-cleaning bit 16 removably coupled to the driver 12.

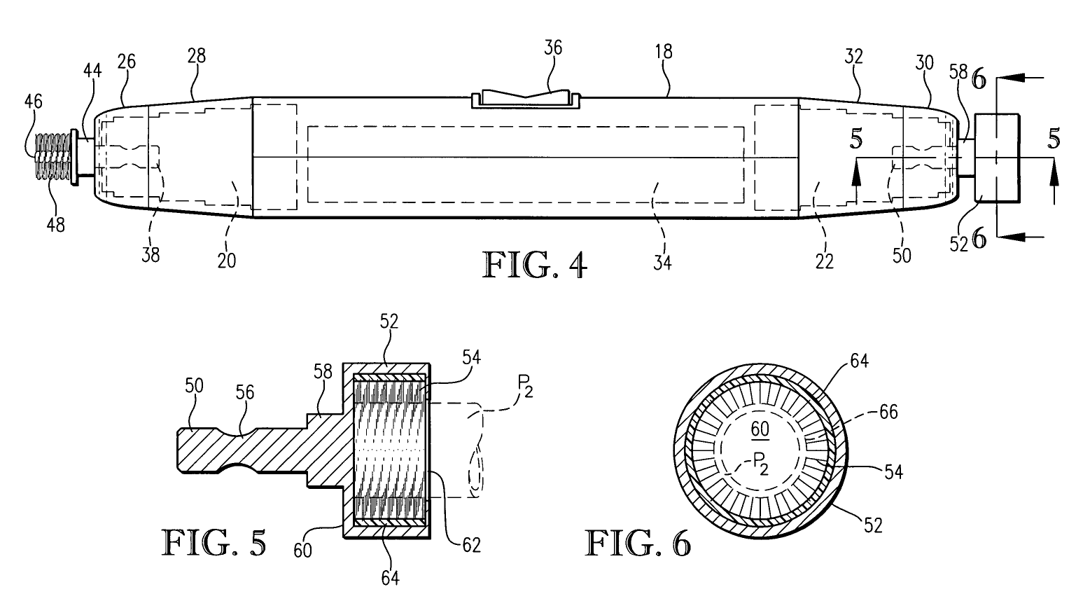

As shown in FIGS. 1 and 4, the illustrated driver 12 includes a housing 18, a first socket 20 rotatably supported on the housing 18, a second socket 22 rotatably supported on the housing 18, and a power source 24 in power communication with the first and second sockets 20 and 22 for selectively rotating the sockets 20, 22. In more detail, the housing 18 is a cylindrically shaped tube configured to fit within the hand of a user (see FIG. 1). The housing 18 is preferably formed of a lightweight yet durable material (e.g., plastic, metal, etc.). The cylindrical housing 18 includes open opposite axially spaced ends each configured for receiving a respective one of the sockets 20, 22.

As shown in FIG. 4, the first socket 20 is rotatably received in one of the open axial ends of the cylindrical housing 18. The first socket 20 is configured to removably receive the inner pipe cleaning bit 14. In particular, the socket 20 is adjustable relative to a bit received therein. In a manner known in the art, the illustrated socket 20 includes an inner recess 20a that receives the bit (see FIG. 3). The inner recess 20a is selectively expandable and contractible so that the bit can be received in the recess 20a of the socket 20, and once received therein the recess 20a can be contracted around the bit to secure the bit therein. Particularly, in a manner known in the art, the illustrated socket 20 includes an end section 26 that is rotatable relative to a base section 28 (e.g., threadably received thereon, etc.). In this manner, when the end section 26 is rotated in one direction relative to the base section 28 (e.g., in a leftward direction when viewed as illustrated in FIG. 4), the inner recess 20a of the socket 20 expands. When the end section 26 is rotated relative to the base section in the opposite direction (e.g., in a rightward direction when viewed as illustrated in FIG. 4), the inner recess 20a contracts. The inner recess 20a of the socket 20 is configured to generally match the shape of the bit received therein. In the illustrated tool 10, the inner recess 20a of the socket 20 presents a generally hexagonal configuration.

The second socket 22 is rotatably received in the axial end of the housing 18 opposite of the housing axial end that the first socket 20 is received in. The socket 22 is configured virtually identically to the previously described socket 20 and accordingly will not be further described in detail. Suffice it to say, the socket 22 includes a generally hexagonal shape, a recess that is expandable and contractible, and an end section 30 rotatable relative to a base section 32. Accordingly, the socket 22 operates in the same manner as previously described in regards to the first socket 20.

It is within the ambit of the present invention to utilize various alternative configurations for each of the sockets. For example, there are several methods of operation known in the art for power driver sockets, and any of these may be utilized for each of the sockets. However, it is important that each of the sockets be configured to removably receive a corresponding one of the bits and cooperate with the power source to selectively rotate the corresponding bit received therein.

As shown in FIG. 4, the illustrated power source 24 includes a rotary motor 34 and a control switch 36. The illustrated rotary motor 34 is a variable speed, reversible motor in power communication with each of the sockets 20 and 22 in any suitable manner known in the art (e.g., power shaft, gears, belts, etc.). The rotary motor 34 is preferably battery powered so as to enable the tool 10 to be easily portable. The battery is preferably contained in the housing so as to be easily removable for replacement or configured for rechargeability while in the housing.

The control switch 36 is in control communication with the rotary motor 34. In particular, in one manner known in the art, the control switch 36 can be toggled between an “off” position as illustrated in FIG. 4 and either one of two “on” positions. When the side of the control switch 36 that is proximate to the first socket 20 is depressed, this corresponds to a first “on” position as illustrated in FIG. 1 wherein the rotary motor 34 causes the first socket 20 to rotate. When the opposite side of the control switch 36 (i.e., the side proximate to the second socket 22) is depressed, this corresponds with a second “on” position as illustrated in FIG. 2 wherein the rotary motor 34 causes the second socket 22 to rotate. Each of the sockets 20 and 22, when rotating, rotate about a central rotational axis that is generally equivalent with the axial center of the cylindrical housing 18. When rotating, each of the sockets 20 and 22 rotate in a clockwise direction when viewed from the respective end along the rotational axis (see FIGS. 1 and 2).

It is within the ambit of the present invention to utilize various alternative configurations for the power source and first and second socket combination. For example, it is within the ambit of the present invention to utilize two independent power sources so that each socket is associated with its own stand-alone power source, so that the sockets could be independently, and/or simultaneously, rotated. Furthermore, it is within the ambit of the present invention to utilize various alternative configurations other than the axial spacing wherein the first and second sockets share a common rotational axis. For example, the first and second sockets could each rotate about a separate rotational axis wherein the rotational axes are spaced from each other at the same end of the driver, or wherein the axes are nonparallel and located at various positions along the driver, etc.

Turning to FIGS. 1 and 3, the inner pipe-cleaning bit 14 is removably received within the first socket 20 for selective rotation about the rotational axis. In more detail, the inner pipe-cleaning bit 14 includes a shaft 38 and a brush 40 fixed relative to the shaft 38. The illustrated shaft 38 is generally hexagonal in shape to complement the shape of the inner recess 20a of the first socket 20 (see FIG. 3). The illustrated shaft 38 further includes a radially-recessed section 42 that presents a smaller circumference relative to the rest of the shaft 38. In this manner, the bit 14 can be used in virtually any socket-type driver, including sockets equipped with a quick-release style attachment, as is known in the art. The shaft 38 includes a brush end 44 that presents a circumference that is greater than the circumference presented by the hexagonal-shaped section of the shaft 38. In this manner, when the inner pipe-cleaning bit 14 is inserted into the first socket 20, and the inner recess 20a of the first socket 20 is securely contracted around the portion of the shaft 38 received in the recess 20a, the brush end 44 rests against the axial end of the first socket 20, for example, to set the depth of the bit 14 within the socket 20 (see FIG. 4).

The brush 40 is fixed to the brush end 44 of the shaft 38. The brush 40 includes a mandrel 46 and a plurality of bristles 48 fixed relative to the mandrel 46 and extending therefrom. The illustrated mandrel 46 is a central mandrel that is generally coaxial with the rotational axis. In this manner, the plurality of bristles 48 extend radially outward from both the mandrel 46 and the axis of rotation. However, it is within the ambit of the present invention to utilize various alternative mandrel designs, for example a curvilinear mandrel that is not coaxial with the rotational axis or a woven wire mandrel as is known in the art.

The illustrated brush 40 is a wire brush and thus the plurality of bristles 48 are formed of wire. The bristles 48 are arranged around the mandrel 46 in a coiled configuration (see FIG. 4). In this manner, the coiled configuration presents an outer margin defining varying circumferences. The outermost circumference of the margin is preferably oversized relative to the inner circumferential surface of the end of the pipe P₁ to be cleaned. In this manner, when the plurality of bristles 48 are inserted into the end of the pipe P₁, the outside circumferential margin of the bristles 48 engages the inner circumferential surface of the end of the pipe P₁. Therefore, when the brush 40 of the bit 14 is inserted into the end of the pipe P₁ and the first socket 20 is rotated, the plurality of bristles 48 effectively clean and debur the inner circumferential surface of the end of the pipe P₁.

Typical plumbing piping has industry standard inner and outer diameters. For example, copper supply pipe typically has a five-eighths inch outer diameter and a one-half inch inner diameter. The corresponding fittings will have a complemental inner diameter (e.g., five-eighths inch). The illustrated plurality of bristles 48 having a coiled configuration enable the brush 40 of the bit 14 to adequately clean and debur the inside circumferential surfaces of both the pipe sections and the fittings. However, it is within the ambit of the present invention to utilize various alternative configurations for the brush, including the plurality of bristles. For example, the plurality of bristles could present a tapered configuration wherein the bristles located adjacent the end of the mandrel distal to the shaft present a smaller outer circumferential margin and the bristles located toward the middle of the mandrel present a relatively greater outer circumferential margin. In this manner, the brush could accommodate a wide variety of pipe sizes.

The outer pipe-cleaning bit 16 is removably received in the second socket 22 for rotation about the rotational axis and is configured for cleaning the outside circumferential surface of the end of the pipes P₁ and P₂ when rotated by the driver 12. In more detail, and as shown in FIGS. 1-6, the outer pipe cleaning bit 16 includes a shaft 50, a cylinder 52 fixed relative to the shaft 50, and a plurality of bristles 54 fixed relative to the cylinder 52. The illustrated shaft 50 is virtually identically configured as the previously discussed shaft 38 and is generally hexagonal in shape including a radially-recessed section 56 and a cylinder end 58 (similar to the brush end 44 of the shaft 38). Accordingly, the shaft 50 operates in a manner very similar to the previously discussed operation of the shaft 38 and thus will not be further described in detail.

As shown in FIGS. 3, 5 and 6, the cylinder 52 includes a closed end 60 and an opposite open end 62 axially spaced from the closed end 60. The closed end 60 is fixed to the cylinder end 58 of the shaft 50. The cylinder 52 presents an inner circumferential surface extending between the closed and open ends 60, 62 and being spaced from the rotational axis. When the end of the pipe P₂ is inserted into the cylinder 52, the spacing between the closed and open ends 60 and 62 operates as a depth guide or stop so that when the end of the pipe P₂ engages the closed end 60, the portion of the end of the pipe P₂ to be cleaned and deburred is positioned within the cylinder 52 (e.g., between one-half and one inch for most pipe cleaning applications).

The plurality of bristles 54 are fixed relative to the inner circumferential surface of the cylinder 52 and extend between the closed and open ends 60, 62. The illustrated plurality of bristles 54 are wire bristles that are fixed to a flexible backing sheet 64 (e.g., formed of plastic, etc.) (see FIGS. 5 and 6). In one manner known in the art, the wire bristles 54 are staple-like bristles that are tacked through the back of the backing material 64. The backing material 64 is fixed rigidly to the inner circumferential surface of the cylinder 52.

The plurality of bristles 54 extend radially inward from the inner circumferential surface of the cylinder 52 toward the rotational axis to present an inner circumferential margin 66 (see FIG. 6). The inner circumferential margin 66 is preferably undersized relative to the outer circumferential surface of the end of the pipe P₂ so that when the end of the pipe P₂ is inserted into the cylinder 52, the plurality of bristles 54 engage the outer circumferential surface of the end of the pipe P₂ at the inner circumferential margin 66. In this manner, the inner circumferential margin 66 of the plurality of bristles 54 sufficiently engages the outer circumferential surface of the end of the pipe P₂ to effectively clean and debur the outer circumferential surface of the pipe P₂ when the outer pipe-cleaning bit 16 is rotated by the driver 12.

The removable nature of the inner and outer pipe-cleaning bits 14, 16 provide for the tool 10 to enable the user to use a single tool to perform a wide variety of plumbing applications. For example, the tool could include multiple sets of inner pipe-cleaning bits and/or outer pipe-cleaning bits that are sized and configured to correspond to variously sized pipes. In this manner, the user could simply, quickly and easily change bits to clean and debur pipes having different sized inner and outer diameters. Additionally, the user could use the same tool to perform relatively larger jobs, by simply replacing a worn-out inner or outer pipe-cleaning bit with a new bit, without having to replace the entire tool. Furthermore, the powered nature of the driver enables the user to use the tool for extended periods of time without becoming overly fatigued. However, it is within the ambit of the present invention to utilize various alternative configurations for the bit and driver combinations. For example, the inner and/or outer pipe-cleaning bits could be used with virtually any rotary driver. Additionally, the inner and/or outer pipe-cleaning bits and one or more drivers could be manufactured as a set wherein one or more of the bits is fixed in one or more of the drivers to form a tool wherein the bits are not removable.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A pipe-cleaning bit for cleaning the inner circumferential surface of the end of a pipe when used in a power driver including at least one rotatable socket, said bit comprising:
a shaft presenting a rotational axis and being operable to removably couple with the socket; and
a brush fixed relative to the shaft and including a plurality of bristles, at least some of which extend radially outward from the rotational axis, for cleaning the inner circumferential surface of the end of the pipe when the shaft is rotated.

2. The bit as claimed in claim 1,
said shaft presenting a socket end and an opposite brush end spaced from the socket end,
said socket end including at least a portion thereof configured to be received in the socket.

3. The bit as claimed in claim 2,
said at least a portion of the socket end defining a hexagonal cross section.

4. The bit as claimed in claim 1,
said brush including a mandrel,
said plurality of bristles being fixed relative to the mandrel and extending therefrom.

5. The bit as claimed in claim 4,
said mandrel being generally coaxial with the rotational axis.

6. The bit as claimed in claim 4,
said plurality of bristles being arranged around the mandrel in a coiled configuration.

7. The bit as claimed in claim 6,
said plurality of bristles being formed of wire.

8. The bit as claimed in claim 7,
said coiled configuration of the plurality of bristles presenting an outer circumferential margin that is oversized relative to the inner circumferential surface of the end of the pipe so that when the plurality of bristles are inserted into the end of the pipe the outside circumferential margin engages the inner circumferential surface of the end of the pipe.

9. A pipe-cleaning bit for cleaning the outside circumferential surface of the end of a pipe when used in a power driver including at least one rotatable socket, said bit comprising:
a shaft operable to removably couple with the socket;
a cylinder fixed relative to the shaft; and
a plurality of bristles fixed relative to the cylinder, at least some of which extend radially inward relative to the cylinder, for cleaning the outside circumferential surface of the end of the pipe when the shaft is rotated.

10. The bit as claimed in claim 9,
said shaft presenting a socket end and an opposite cylinder end spaced from the socket end,
said socket end including at least a portion thereof configured to be received in the socket.

11. The bit as claimed in claim 9,
said at least a portion of the socket end defining a hexagonal cross section.

12. The bit as claimed in 10,
said cylinder including a closed end adjacent the shaft and an open end opposite the closed end and spaced from the closed end,
said plurality of bristles being located between the closed and open ends.

13. The bit as claimed in claim 12,
said cylinder presenting an inner circumferential surface extending between the closed and open ends,
said plurality of bristles being fixed relative to the inner circumferential surface and extending therefrom.

14. The bit as claimed in claim 13,
said shaft presenting a rotational axis,
said inner circumferential surface being spaced from said rotational axis,
said plurality of bristles extending from the inner circumferential surface toward said rotational axis.

15. The bit as claimed in claim 14,
said plurality of bristles being formed of wire.

16. The bit as claimed in claim 15,
said plurality of bristles presenting an inner circumferential margin spaced from the rotational axis,
said inner circumferential margin being undersized relative to the outer circumferential surface of the end of the pipe so that when the end of the pipe is inserted into the cylinder, the inner circumferential margin engages the outer circumferential surface of the end of the pipe.

17. A double-ended driver for selectively rotating at least a first and a second bit, said driver comprising:
a housing;
a first socket rotatably supported on the housing and operable to removably receive the first bit;
a second socket rotatably supported on the housing and being spaced from the first socket and operable to removably receive the second bit; and
a motorized power source at least partially contained within the housing and being in power communication with the first and second sockets for selectively rotating the sockets.

18. The driver as claimed in claim 17,
said housing being generally tubular shaped and sized to fit in the hand of a user,
said housing presenting a center rotational axis.

19. The driver as claimed in claim 18,
said housing presenting axially opposite first and second ends,
said first socket being supported adjacent the first end for rotation about the rotational axis.

20. The driver as claimed in claim 19,
said second socket being adjacent the second end for rotation about the rotational axis.

21. The driver as claimed in claim 17,
said first and second sockets each including a chucking mechanism for adjustably securing a bit received in the socket.

22. The driver as claimed in claim 17,
said first and second sockets being independently and reversably rotatable.

23. The driver as claimed in claim 17,
said motorized power source being self-contained within the housing.

24. The driver as claimed in claim 23,
said motorized power source including a battery.

25. In a power driver, a pipe-cleaning bit for cleaning the end of a pipe, the bit comprising:
a shaft rotatable about a rotational axis; and
a plurality of bristles fixed relative to the shaft and operable to clean the end of the pipe when the shaft is rotated.

26. In the power driver as claimed in claim 25,
said bit being removably received in the power driver.

27. In the power driver as claimed in claim 25,
said plurality of bristles being fixed adjacent the rotational axis and extending therefrom so as to be operable to clean the inside of the pipe when the shaft is rotated.

28. In the power driver as claimed in claim 25,
said plurality of bristles being fixed at a location that is spaced from the rotational axis and extending therefrom toward the rotational axis so as to be operable to clean the outside of the pipe when the shaft is rotated.

29. A tool for cleaning the inside and outside circumferential surfaces of the end of a pipe, said tool comprising:
a driver including a first socket, a second socket spaced from the first socket, and a motorized power source in power communication with the first and second sockets for selectively rotating the sockets;
an inner pipe-cleaning bit removably coupled to the first socket and being operable to clean the inside circumferential surface of the end of the pipe when the first socket is rotated; and
an outer pipe-cleaning bit removably coupled to the second socket and being operable to clean the outside circumferential surface of the end of the pipe when the second socket is rotated.

30. A method for cleaning the inside and outside circumferential surfaces of the end of a pipe, the method comprising the steps of:
(a) coupling a wire brush to a power driver;
(b) inserting the wire brush into the inside of the end of the pipe; and
(c) rotating the wire brush inside the pipe without rotating the hands of the user.

31. The method as claimed in claim 30, further comprising the steps of:
(d) coupling a cylinder of wire bristles to the power driver so that the cylinder is spaced from the wire brush;
(e) removing the wire brush from the end of the pipe and inserting the end of the pipe into the cylinder; and
(f) rotating the cylinder without rotating the hands of the user.

32. The method as claimed in claim 31, step (e) including the step of:
removing the wire brush from the end of the pipe without removing the wire brush from the power driver.

33. The method as claimed in claim 32, step (f) including the step of:
rotating the cylinder without rotating the wire brush.
